(19) United States
(12) Patent Application Publication
(10) Pub. No.: US 2025/0222748 A1
(43) Pub. Date: Jul. 10, 2025

(54) AUTO DEFOG SENSOR

(71) Applicants: HYUNDAI MOTOR COMPANY, SEOUL (KR); KIA CORPORATION, SEOUL (KR); SENSIRION AUTOMOTIVE SOLUTIONS KOREA CO., LTD., Seoul (KR)

(72) Inventors: Byoung Hyun JI, Goyang-si (KR); Heon Seob KIM, Hwaseong-si (KR); Kwang Woon CHO, Yongin-si (KR); Hyung Jin LIM, Suwon-si (KR); Hee Jeong KO, Seoul (KR); Ferrat Pascal, Hombrechtikon (CH)

(21) Appl. No.: 18/668,105

(22) Filed: May 17, 2024

(30) Foreign Application Priority Data
Jan. 10, 2024 (KR) 10-2024-0003937

(51) Int. Cl. B60J 1/00; G01K 1/02; G01K 1/08; G01K 1/14

(52) U.S. Cl. CPC B60J 1/002; G01K 1/026; G01K 1/08; G01K 1/14

(57) ABSTRACT

Provided herein is an auto defog sensor, including a flexible printed circuit board having mounted thereon a first sensor portion configured to measure the surface temperature of a windshield of a vehicle and a second sensor portion configured to measure the interior temperature and humidity of the vehicle, a first housing configured to accommodate therein the flexible printed circuit board and be adhered to the windshield surface, and a second housing coupled to the first housing to shield the flexible printed circuit board and having a passage through which air flows.

### CROSS-REFERENCE TO RELATED APPLICATION

This application claims, under 35 U.S.C. § 119 (a), the benefit of and priority to Korean Patent Application No. 10-2024-0003937, filed on Jan. 10, 2024, the entire contents of which are incorporated herein by reference.

### TECHNICAL FIELD

The present disclosure relates to an auto defog sensor. More particularly, the present disclosure relates to an auto defog sensor having malfunction prevention functionality.

### BACKGROUND

Generally, the interior and exterior of a vehicle have a temperature difference therebetween, so in high humidity environments, water vapor may condense on vehicle windows, causing fogging, which hinders vision.

Fogging increases risk of accidents, and particularly, fogging on the front windshield may block the driver's forward view, resulting in a serious accident.

For this reason, it is necessary to remove moisture from the window and prevent formation of moisture using an air conditioning device, and for this purpose, auto defog sensors are provided for predicting and/or detecting fogging on the window surface.

A general auto defog sensor predicts and/or detects fogging, which begins to form on the window surface, and is linked to an air conditioning system to automatically prevent or remove fogging on the window. Such an auto defog sensor is adopted in vehicle windows, allowing drivers to drive safely.

However, because the auto defog sensor generally measures the surface temperature of the window using a temperature sensor adhered to the window surface by an adhesive member, there is a concern that a gap may be generated between a temperature measurement area and the adhesive member due to various reasons, such as a curved window surface or foreign substances being introduced between the temperature measurement area and the adhesive member.

Moreover, the temperature of the window surface may be erroneously measured, whereby fog may not be effectively predicted and/or detected.

The above information disclosed in this Background section is only for enhancement of understanding of the background of the present disclosure, and therefore it may contain information that does not form the prior art that is already known to a person of ordinary skill in the art.

### SUMMARY

The present disclosure has been made in an effort to solve the above-described problems associated with the prior art, and an object of the present disclosure is to provide an auto defog sensor provided with a first air inlet hole and a second air inlet hole forming a passage through which air flows, wherein the first and second air inlet holes each include an inclined surface extending therefrom, blocking exposure of sensors by the inclined surfaces and preventing liquid and the like from being introduced into a vehicle to thereby prevent measurement error of the sensors.

In one aspect, the present disclosure provides an auto defog sensor, including a flexible printed circuit board having mounted thereon a first sensor portion configured to measure the surface temperature of a windshield of a vehicle and a second sensor portion configured to measure the interior temperature and humidity of the vehicle, a first housing configured to accommodate therein the flexible printed circuit board and be adhered to the windshield surface, and a second housing coupled to the first housing to shield the flexible printed circuit board and having a passage through which air flows.

In one embodiment, the flexible printed circuit board may include a base substrate portion having the second sensor portion mounted thereon, and a curved substrate portion extending in a curved shape from the base substrate portion to apply pressure to the windshield surface.

In another embodiment, the first housing may include an opening to expose the curved substrate portion.

In still another embodiment, the first sensor portion may be mounted on the curved substrate portion.

In yet another embodiment, the second sensor portion may be mounted on the base substrate portion and be shielded by the passage.

In still yet another embodiment, the second housing may include a first passage having a first air flow hole formed in a direction to be coupled to the first housing, and a second passage configured to communicate with the first passage and having a second air flow hole formed in a direction to be coupled to the first housing by being separated from the first air flow hole.

In a further embodiment, the first passage may include a first inclined surface configured to guide air to flow towards the first air flow hole, and the second passage may include a second inclined surface configured to guide air to flow towards the second air flow hole.

In another further embodiment, the first inclined surface may be formed in a direction corresponding to the second inclined surface.

In still another further embodiment, the second inclined surface may have an inclination angle greater than that of the first inclined surface.

Other aspects and embodiments of the present disclosure are discussed infra.

It is to be understood that the term “vehicle” or “vehicular” or other similar terms as used herein are inclusive of motor vehicles in general, such as passenger automobiles including sport utility vehicles (SUV), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is an exploded view showing the state of an auto defog sensor according to an embodiment of the present disclosure;

FIG. 2 is a bottom exploded view showing the state of the auto defog sensor of FIG. 1 according to an embodiment of the present disclosure;

FIG. 3 is a view showing the assembled state of the auto defog sensor of FIG. 1 according to an embodiment of the present disclosure; and

FIG. 4 is a view showing air flow through the auto defog sensor of FIG. 1 according to an embodiment of the present disclosure.

It should be understood that the appended drawings are not necessarily to scale, presenting a somewhat simplified representation of various preferred features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Hereinafter, preferred embodiments according to the present disclosure will be described in detail with reference to the adhered drawings.

Advantages and features of the present disclosure, and a method of achieving the same, will be apparent with reference to the embodiments described below in detail in conjunction with the accompanying drawings.

However, the present disclosure may be embodied in many different forms, and should not be construed as being limited to the embodiments set forth herein. Rather, the embodiments are provided so that the present disclosure will be thorough and complete, and will fully convey the scope of the present disclosure to those skilled in the art. The present disclosure is defined only by the categories of the claims.

In describing the present disclosure, if a detailed explanation of a related known function or construction is considered to unnecessarily obscure the gist of the present disclosure, such explanation has been omitted but would be understood by those skilled in the art.

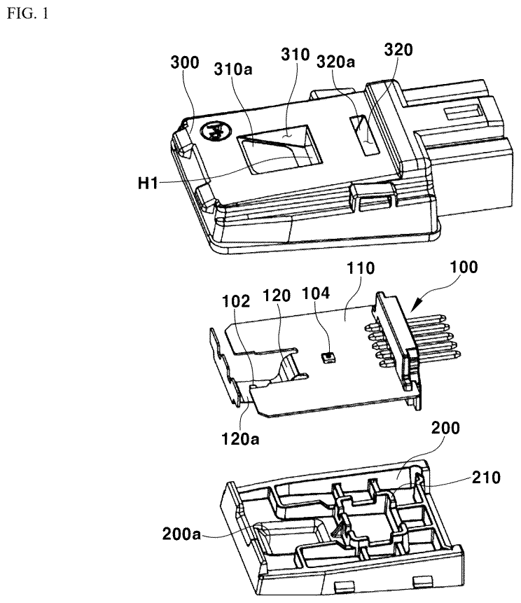

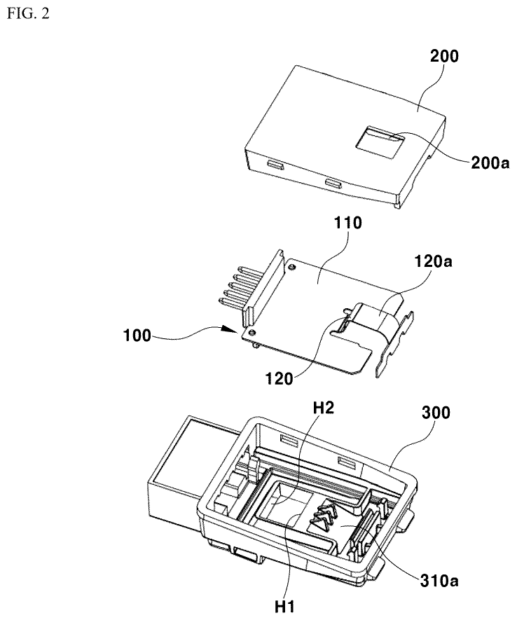

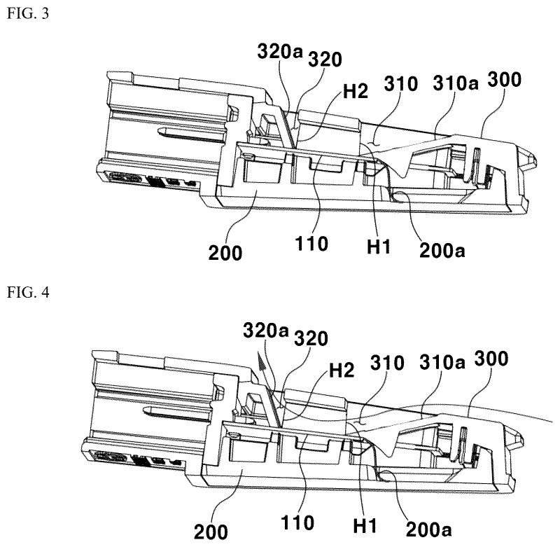

FIG. 1 and FIG. 2 are exploded views showing the state of an auto defog sensor according to an embodiment of the present disclosure, FIG. 3 is a view showing the assembled state of the auto defog sensor according to an embodiment of the present disclosure, and FIG. 4 is a view showing air flow through the auto defog sensor of FIG. 1 according to an embodiment of the present disclosure.

As illustrated in FIG. 1 and FIG. 2, the auto defog sensor according to this embodiment includes a flexible printed circuit board 100, a first housing 200, and a second housing 300.

The flexible printed circuit board 100 has mounted thereon a first sensor portion 102 configured to measure the surface temperature of a windshield of a vehicle, and a second sensor portion 104 configured to measure the interior temperature and humidity of the vehicle.

Specifically, the flexible printed circuit board 100 has mounted thereon the first sensor portion 102a including a temperature sensor configured to measure the surface temperature of the windshield, and the second sensor portion 104 including a temperature sensor configured to measure the interior temperature of the vehicle and a humidity sensor configured to measure the internal humidity of the vehicle.

Preferably, because the second sensor portion 104 includes the temperature sensor and the humidity sensor mounted on the flexible printed circuit board 100 by being separated from each other, the second sensor portion 104 may measure the interior temperature and interior humidity of the vehicle, and more preferably, the temperature sensor and the humidity sensor may be used together with the first sensor portion 102 to accurately calculate the dewpoint temperature.

The flexible printed circuit board 100 includes a base substrate portion 110 and a curved substrate portion 120.

The base substrate portion 110 is disposed within the first housing 200, and, together with the second sensor portion 104, is shielded from the outside environment when the second housing 300 is coupled to the first housing 200.

The base substrate portion 110 may be supported by a hollow support portion 210 of the first housing 200. The hollow support portion 210 has a hollow shape and protrudes towards the second housing 300, and supports the central portion of the base substrate portion 110.

Here, the hollow support portion 210 may have a rectangular shape with a hollow portion, and as such, the base substrate portion 110 is supported by the rim of the first housing 200 and the hollow support portion 210. Therefore, the base substrate portion 110 and the curved substrate portion 120 may be insulated by the rim of the first housing 200 and the hollow in the hollow support portion 210, and accordingly, the base substrate portion 110 and the curved substrate portion 120 may be insulated from the surrounding heat, allowing the first sensor portion 102 to more accurately measure the temperature of a windshield surface 10.

Moreover, the base substrate portion 110 may have a structure in which a circuit is formed on a substrate made of a material having bendable characteristics.

With this structure, the curved substrate portion 120 extends in a curved shape from the base substrate portion 110 to apply pressure to the windshield surface.

The curved substrate portion 120 includes a contact portion 120a, and the curved substrate portion 120 extends from the base substrate portion 110 in a curved shape having a predetermined length, allowing the contact portion 120a to be drawn out through an opening 200a in the first housing 200 to press against the windshield surface.

Here, the curved substrate portion 120 is configured to form to, or press against, not only the surface of the windshield but the surface of the window, mirror, etc., and has its own tension.

In other words, the curved substrate portion 120, having qualities such as being naturally bendable, is integrated with the base substrate portion 110 and is connected to the base substrate portion 110 through circuits.

Because the curved substrate portion 120 is bent and deformed as it contacts the windshield surface in a state in which the contact portion 120a is drawn out through the opening 200a in the first housing 200, the curved substrate portion 120 may be kept in close contact with the windshield surface by the tension. For this reason, even though the windshield surface is curved, the contact portion 120a may deform to coincide with the curved shape of the windshield surface, bringing the curved substrate portion 120 effectively into close contact with the windshield surface by the tension.

In other words, when the contact portion 120a is brought into contact with the windshield surface, the curved substrate portion 120 may act as a spring via the tension, and as such, the curved substrate portion 120 may, without a pressing means such as an additional spring or pressure rod, not only improve thermal contact with the windshield surface but minimize thermal mass owing to omitting additional pressing means.

The contact portion 120a has an inner side on which the first sensor portion 102 is mounted. The first sensor portion 102 is a temperature sensor, and is configured to measure the surface temperature of the windshield via the curved substrate portion 120 in a state in which the contact portion 120a is brought into contact with the windshield surface.

As such, because the curved substrate portion 120 may be kept in close contact with the windshield surface by its own tension, even though the windshield surface is curved, in a state in which the contact portion 120a is drawn out through the opening 200a in the first housing 200 to come in contact with the windshield surface, the first sensor portion 102 may rapidly and accurately measure the temperature of the windshield surface through the curved substrate portion 120, allowing for a quick and accurate response to changes in fogging conditions to thereby effectively remove fogging on the windshield surface.

Meanwhile, the first housing 200 accommodates the flexible printed circuit board 100 therein and is adhered to the windshield surface.

In other words, the first housing 200 may be adhered to the windshield surface using a separate adhesive member (not shown). Here, the adhesive member (not shown) may have a shape, for example, corresponding to that of the first housing 200, excluding the opening 200a.

The adhesive member (not shown) may have adhesiveness on both sides, and therefore one adhesive side may be adhered to the first housing 200, excluding the opening 200a, and the other adhesive side may be adhered to the windshield surface, allowing the first housing 200 including the flexible printed circuit board 100 and the second housing 300 to be stably adhered to the windshield surface.

More preferably, the adhesive member (not shown) may be made of a soft material, for example, a double-sided tape, so that the adhesive member has a sufficient adhesive force even when the first housing 200 is adhered to a curved windshield surface.

Meanwhile, the second housing 300 is coupled to the first housing 200 to shield the flexible printed circuit board 100, which is disposed inside, from outside, and has a passage through which air flows.

Specifically, the second housing 300 includes, as illustrated in FIG. 3, a first passage 310 and a second passage 320.

The first passage 310 includes a first air flow hole H1 formed in a direction to be coupled to the first housing 200 (see FIG. 1).

Moreover, the second passage 320 communicates with the first passage 310, and includes a second air flow hole H2 formed in a direction to be coupled to the first housing 200 by being separated from the first air flow hole H1 (see FIG. 2).

Here, the first passage 310 includes a first inclined surface 310a configured to guide air to flow towards the first air flow hole H1, and the second passage 320 includes a second inclined surface 320a configured to guide air to flow towards the second air flow hole H2.

Preferably, the first inclined surface 310a of the first passage 310 has an inclination in a direction corresponding to the second inclined surface 320a of the second passage 320, and more preferably, the first inclined surface 310a of the first passage 310 extends to have a greater length (area) and a smaller inclination angle than the second inclined surface 320a of the second passage 320.

Above structure is to allow for efficient air flow. When air flows into the first air flow hole H1 in the first passage 310 along the first inclined surface 310a and is introduced into the first housing 200 and the second housing 300 in the direction of the arrow shown in FIG. 4, the air flows through the second air flow hole H2, facing the first air flow hole H1, to be discharged through the second passage 320 along the second inclined surface 320a. Here, as described above, the first inclined surface 310a and the second inclined surface 320a have differences in inclination direction, length (area), and inclination angle, facilitating the flow of air being introduced and discharged.

Conventionally, a separate filter was installed to prevent foreign substances from flowing into the flexible printed circuit board 100, which inevitably caused a problem that there has to be installed a structure for mounting the filter.

In this sense, the filter may be removed from the second housing 300 to solve the problem. However without the filter, the second sensor portion 104 is directly exposed to the outside, so when liquid sprayed onto the windshield from inside the vehicle is introduced into the second sensor portion 104, it may cause malfunction of the sensor.

For this reason, in the present embodiment, a structure such as the first passage 310 including the first inclined surface 310a and the second passage 320 including the second inclined surface 320a, each configured to block exposure of the first housing 200 and second housing 300 including the second sensor portion 104, is adopted, allowing the inflow and discharge of air flowing along the first inclined surface 310a and the second inclined surface 320a through the first air flow hole H1 and second air flow hole H2, respectively. Therefore, when liquid and the like are introduced into the first housing 200 and second housing 300 due to the removal of the filter, moisture may be easily evaporated by the flow of air, preventing measurement errors of the second sensor portion 104, and eventually, improving measurement accuracy of the second sensor portion 104, which measures the interior temperature and humidity.

Thus, according to the present disclosure, an auto defog sensor is provided with a first air inlet hole and a second air inlet hole forming a passage through which air flows, wherein the first and second air inlet holes each include an inclined surface extending therefrom, blocking exposure of sensors by the inclined surfaces and preventing liquid and the like from being introduced into a vehicle to thereby prevent measurement error of the sensors.

Furthermore, according to the present disclosure, air flow may be facilitated by the first and second air inlet holes, allowing the flowing air to directly reach the sensor to thereby improve the sensing speed and measurement accuracy of the sensor.

In the above, embodiments of the present disclosure have been described with reference to the accompanying drawings. However, those skilled in the art to which the present disclosure pertains will understand that various modifications may be made therefrom, and that all or part of the above-described embodiments may be selectively combined. Therefore, the true technical protection scope of the present disclosure should be determined by the technical ideas of the appended claims.

What is claimed is:

1. An auto defog sensor, comprising:
a flexible printed circuit board having mounted thereon a first sensor portion configured to measure a surface temperature of a windshield of a vehicle, and a second sensor portion configured to measure an interior temperature and humidity of the vehicle;
a first housing configured to accommodate therein the flexible printed circuit board and be adhered to the windshield surface; and
a second housing coupled to the first housing to shield the flexible printed circuit board, and having a passage through which air flows.

2. The auto defog sensor of claim 1, wherein the flexible printed circuit board comprises:
a base substrate portion having the second sensor portion mounted thereon; and
a curved substrate portion extending in a curved shape from the base substrate portion to apply pressure to the windshield surface.

3. The auto defog sensor of claim 2, wherein the first housing comprises an opening to expose the curved substrate portion.

4. The auto defog sensor of claim 2, wherein the first sensor portion is mounted on the curved substrate portion.

5. The auto defog sensor of claim 2, wherein the second sensor portion is mounted on the base substrate portion and is shielded by the passage.

6. The auto defog sensor of claim 1, wherein the second housing comprises:
a first passage having a first air flow hole formed in a direction to be coupled to the first housing; and
a second passage configured to communicate with the first passage, and having a second air flow hole formed in a direction to be coupled to the first housing by being separated from the first air flow hole.

7. The auto defog sensor of claim 6, wherein:
the first passage comprises a first inclined surface configured to guide air to flow towards the first air flow hole, and
the second passage comprises a second inclined surface configured to guide air to flow towards the second air flow hole.

8. The auto defog sensor of claim 7, wherein the first inclined surface is formed in a direction corresponding to the second inclined surface.

9. The auto defog sensor of claim 7, wherein the second inclined surface has an inclination angle greater than that of the first inclined surface.
